(19) United States
(12) Patent Application Publication
(10) Pub. No.: US 2025/0138295 A1
(43) Pub. Date: May 1, 2025

(54) DARK-FIELD CONFOCAL MICROSCOPIC MEASUREMENT APPARATUS AND METHOD BASED ON FREQUENCY MISMATCH DEMODULATION

(71) Applicant: Harbin Institute of Technology, Harbin City, Heilongjiang Province (CN)

(72) Inventors: Jian LIU, Harbin City (CN); Chenguang LIU, Harbin City (CN); Zijie HUA, Harbin City (CN)

(21) Appl. No.: 18/776,664

(22) Filed: Jul. 18, 2024

(30) Foreign Application Priority Data
Oct. 31, 2023 (CN) 202311426287.X

(51) Int. Cl. G02B 21/00; G01N 21/88; G02B 21/10

(52) U.S. Cl. CPC G02B 21/0032; G01N 21/8806; G02B 21/0036; G02B 21/10

(57) ABSTRACT

Provided are a dark-field confocal microscopic measurement apparatus and method based on frequency mismatch demodulation, relating to a dark-field confocal microscopic measurement apparatus and method. The problems that lateral and axial resolutions are affected and the stability of a microscopic system is reduced because the traditional nondestructive testing technology of subsurface defects in dark-field confocal microscopic measurement relies on a complex beam shaping mechanism are solved. The apparatus includes a dual-channel waveform generator, a modulated illumination module, an optical scanning module, a mismatch demodulation module, and an axial displacement table. A sample is placed on the axial displacement table, and one channel of the dual-channel waveform generator is connected to the modulated illumination module. Laser emitted by the modulated illumination module irradiates the sample through the optical scanning module, and returned light of the sample is collected by the mismatch demodulation module.

### CROSS-REFERENCE TO RELATED APPLICATION

This patent application claims the benefit and priority of Chinese Patent Application No. 202311426287X, filed with the China National Intellectual Property Administration on Oct. 31, 2023, the disclosure of which is incorporated by reference herein in its entirety as part of the present application.

### TECHNICAL FIELD

The present disclosure relates to a dark-field confocal microscopic measurement apparatus and method, belonging to the technical field of optical precision measurement.

### BACKGROUND

In the processing of high-performance advanced optical components, impurities, scratches, microcracks and other defects will inevitably occur below the surface, i.e., subsurface defects, which are prone to affecting the mechanical properties and service life of the components. Especially in high-energy laser systems, the existence of subsurface defects reduces the damage stress of materials, provides an accommodation space for light-absorption impurities, and produces strong scattering and beam modulation of incident high-energy laser, greatly reducing a laser damage threshold of the optical components. How to effectively detect and suppress subsurface defects has become a “bottleneck” problem that limits the manufacturing precision of optical components, the production efficiency of core components and the power density of high-energy laser.

Dark-field confocal microscopic measurement technology, due to its good optical tomographic ability and high imaging resolution and signal-to-noise ratio, and has become an important means for detection of surface and subsurface defects of optical components. However, the traditional nondestructive testing technology of subsurface defects in dark-field confocal microscopic measurement relies on a complex beam shaping mechanism, which affects lateral and axial resolutions, and reduces the stability of a microscopic system. Therefore, the reliability of the subsurface defects detection can be effectively improved by realizing dark-field imaging without illumination light shaping.

### SUMMARY

To solve the problems that lateral and axial resolutions are affected and the stability of a microscopic system is reduced because the traditional nondestructive testing technology of subsurface defects in dark-field confocal microscopic measurement relies on a complex beam shaping mechanism, a dark-field confocal microscopic measurement apparatus and method based on frequency mismatch demodulation are provided.

The technical solution adopted by the present disclosure to solve the problems above is as follows: the apparatus includes a dual-channel waveform generator, a modulated illumination module, an optical scanning module, a mismatch demodulation module, and an axial displacement table. A sample is placed on the axial displacement table, and one channel of the dual-channel waveform generator is connected to the modulated illumination module. Laser emitted by the modulated illumination module irradiates the sample through the optical scanning module, and returned light of the sample is collected by the mismatch demodulation module.

Further, the modulated illumination module includes an LD laser device, a single-mode fiber, a fiber collimator lens, and a unpolarized beam splitter. The LD laser device, the single-mode fiber, the fiber collimator lens and the unpolarized beam splitter are sequentially arranged from left to right. The LD laser device is connected to one channel of the dual-channel waveform generator, and laser emitted by the LD laser device enters the optical scanning module via the single-mode fiber, the fiber collimator lens and the unpolarized beam splitter.

Further, the optical scanning module includes a galvanometer, a scanning lens, a tube lens, and an objective lens. The galvanometer, the scanning lens, the tube lens and the objective lens are arranged in sequence, and laser emitted by the LD laser device enters the galvanometer after passing through the single-mode fiber, the fiber collimator and the unpolarized beam splitter in sequence, and then irradiates the sample after passing through the scanning lens, the tube lens and the objective lens in sequence.

Further, the mismatch demodulation module comprises a focusing lens, a pinhole, a PMT (Photomultiplier tube) detector, and a lock-in amplifier. The returned light of the sample is focused to the pinhole by the focusing lens and collected by the PMT detector, and an output electric signal of the PMT detector is connected to an input channel of the lock-in amplifier.

Further, one channel of the dual-channel waveform generator outputs a square-wave pulse sequence with a frequency of f to the LD laser device, 500 kHz≤f≤10 MHz, and the LD laser device outputs intensity-modulated linearly polarized laser with a modulation frequency of f.

Further, the other channel of the dual-channel waveform generator outputs a trigonometric function signal with a frequency of f+Δf to the lock-in amplifier as a reference waveform, and an output electric signal of the PMT detector is connected to an input channel of the lock-in amplifier, Δf is set to f/10.

Further, a demodulation frequency of the lock-in amplifier (15) is f+Δf, and an output analog signal is collected, which is used to synchronously reconstruct a dark-field microscopic imaging result with scanning of the galvanometer.

A dark-field confocal microscopic measurement method includes the following steps:
Step 1, outputting, by one channel of a dual-channel waveform generator, a square-wave pulse sequence with a frequency of f to an LD laser device, and outputting, by the LD laser device, intensity-modified linearly polarized laser with a modulation frequency of f,
Step 2, outputting, by a fiber collimator lens, collimated light after the single-mode fiber is coupled with the laser, where the collimated light enters an optical scanning module through a non-polarized beam splitter, and then focuses on a sample through a galvanometer, a scanning lens, a tube lens and an objective lens;
Step 3, scanning a position of a focused spot by a galvanometer, and controlling a scanning rate of the galvanometer, thus making residence time of each scanning point more than 2/f;
Step 4, focusing returned light of the sample to a pinhole through a focusing lens, and collecting the returned light by the PMT detector;
Step 5, connecting an output electric signal of the PMT detector to an input channel of a lock-in amplifier, and outputting, by the other channel of the dual-channel waveform generator, a trigonometric function signal with a frequency of f+Δf to a reference channel of the lock-inn amplifier;
Step 6, setting a demodulation frequency of the lock-in amplifier to f+Δf, and a mode to external reference; and collecting an output analog signal, which is used to synchronously reconstruct a dark-field microscopic imaging result with scanning of the galvanometer; and
Step 7, stepwise moving an axial displacement table by one step value to scan an axial position of the sample, and repeating Steps 1-6.

The present disclosure has the beneficial effects that:

1. A solid focused spot is used to illuminate the sample, making the field of view more uniform. Moreover, the system resolution is higher than that of a dark-field confocal microscope system with ring-shaped light illumination.

2. The defect detection with higher sensitivity can be achieved using the lock-in amplification demodulation technology.

### BRIEF DESCRIPTION OF THE DRAWINGS

FIG. 1 is a structural diagram of a dark-field confocal microscopic measurement apparatus according to the present disclosure.

### DETAILED DESCRIPTION OF THE EMBODIMENTS

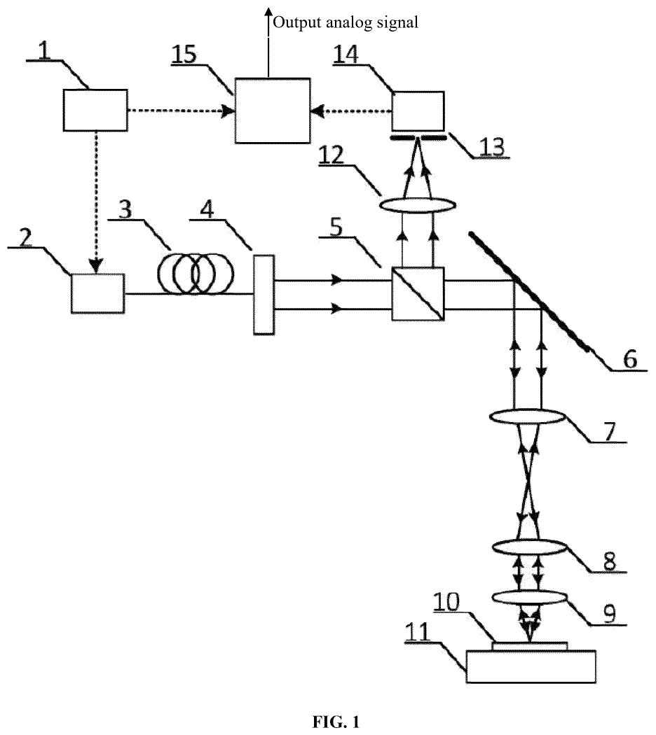

Specific embodiment 1: this embodiment is described in conjunction with FIG. 1, a dark-field confocal microscopic measurement apparatus based on frequency mismatch demodulation includes a dual-channel waveform generator 1, a modulated illumination module, an optical scanning module, a mismatch demodulation module, and an axial displacement table 11. A sample 10 is placed on the axial displacement table 11, and one channel of the dual-channel waveform generator 1 is connected to the modulated illumination module. Laser emitted by the modulated illumination module irradiates the sample 10 through the optical scanning module, and returned light of the sample 10 is collected by the mismatch demodulation module.

Specific embodiment 2: this embodiment is described in conjunction with FIG. 1, the modulated illumination module of the dark-field confocal microscopic measurement apparatus based on frequency mismatch demodulation includes an LD laser device 2, a single-mode fiber 3, a fiber collimator 4, and a unpolarized beam splitter 5. The LD laser device 2, the single-mode fiber 3, the fiber collimator lens 4 and the unpolarized beam splitter 5 are sequentially arranged from left to right. The LD laser device 2 is connected to one channel of the dual-channel waveform generator 1, and laser emitted by the LD laser device 2 enters the optical scanning module via the single-mode fiber 3, the fiber collimator lens 4 and the unpolarized beam splitter 5.

Specific embodiment 3: this embodiment is described in conjunction with FIG. 1, the optical scanning module of the dark-field confocal microscopic measurement apparatus based on frequency mismatch demodulation includes a galvanometer 6, a scanning lens 7, a tube lens 8, and an objective lens 9. The galvanometer 6, the scanning lens 7, the tube lens 8 and the objective lens 9 are arranged in sequence, and laser emitted by the LD laser device 2 enters the galvanometer 6 after passing through the single-mode fiber 3, the fiber collimator 4 and the unpolarized beam splitter 5 in sequence, and then irradiates the sample 10 after passing through the scanning lens 7, the tube lens 8 and the objective lens 9 in sequence.

Specific embodiment 4, this embodiment is described in conjunction with FIG. 1, the mismatch demodulation module of the dark-field confocal microscopic measurement apparatus based on frequency mismatch demodulation includes a focusing lens 12, a pinhole 13, a PMT detector 14, and a lock-in amplifier 15. The returned light of the sample 10 is focused to the pinhole 13 by the focusing lens 12 and collected by the PMT detector 14, and an output electric signal of the PMT detector 14 is connected to an input channel of the lock-in amplifier 15.

Specific embodiment 5, this embodiment is described in conjunction with FIG. 1, one channel of the dual-channel waveform generator 1 of the dark-field confocal microscopic measurement apparatus based on frequency mismatch demodulation outputs a square-wave pulse sequence with a frequency of f to the LD laser device 2, 500 kHz≤f≤10 MHz, and the LD laser device 2 outputs intensity-modulated linearly polarized laser with a modulation frequency of f.

Specific embodiment 6, this embodiment is described in conjunction with FIG. 1, the other channel of the dual-channel waveform generator 1 of the dark-field confocal microscopic measurement apparatus based on frequency mismatch demodulation outputs a trigonometric function signal with a frequency of f+Δf to the lock-in amplifier 15 as a reference waveform. An output electric signal of the PMT detector 14 is connected to an input channel of the lock-in amplifier 15, and Δf is set to f/10.

Specific embodiment 7, this embodiment is described in conjunction with FIG. 1, a demodulation frequency of the lock-in amplifier 15 of the dark-field confocal microscopic measurement apparatus based on frequency mismatch demodulation is f+Δf, and an output analog signal is collected, which is used to synchronously reconstruct a dark-field microscopic imaging result with scanning of the galvanometer 6.

Specific embodiment 8, this embodiment is described in conjunction with FIG. 1, a dark-field confocal microscopic measurement method based on frequency mismatch demodulation in this embodiment includes the following steps:

Step 1. One channel of a dual-channel waveform generator 1 outputs a square-wave pulse sequence with a frequency of f to an LD laser device 2, and the LD laser device 2 outputs intensity-modified linearly polarized laser with a modulation frequency of f.

Step 2. A fiber collimator 4 outputs collimated light after the single-mode fiber 3 is coupled with the laser, where the collimated light enters an optical scanning module through a non-polarized beam splitter 5, and then focuses on a sample 10 through a galvanometer 6, a scanning lens 7, a tube lens 9 and an objective lens 9.

Step 3. A position of a focused spot is scanned by the galvanometer 6, and a scanning rate of the galvanometer 6 is controlled to make residence time of each scanning point more than 2/f.

Step 4. The returned light of the sample 10 is focused to a pinhole 13 through a focusing lens 12, and collected by the PMT detector 14.

Step 5. An output electric signal of the PMT detector 14 is connected to an input channel of the lock-in amplifier 15, and the other channel of the dual-channel waveform generator 1 outputs a trigonometric function signal with a frequency of f+Δf to a reference channel of the lock-in amplifier 15.

Step 6. A demodulation frequency of the lock-in amplifier (15) is f+Δf, and an output analog signal is collected, which is used to synchronously reconstruct a dark-field microscopic imaging result with the scanning of the galvanometer 6.

Step 7. An axial displacement table 11 is stepwise moved by one step value to scan an axial position of the sample, and Steps 1-6 are repeated.

The foregoing is merely illustrative of the preferred embodiments of the present disclosure and is not intended to limit the present disclosure in any form. While the present disclosure has been disclosed with reference to the preferred embodiments, it is not intended to limit the present disclosure. Any person skilled in the art will, without departing from the scope of the technical solution of the present disclosure, may make use of the technical contents disclosed above to make some alterations or modifications to equivalent embodiments, but without departing from the scope of the technical solution of the present disclosure. Any simple modifications, equivalent replacements, and improvements made to the foregoing embodiments within the spirit and principle of the present disclosure are within the scope of the present disclosure according to the technical essence of the present disclosure.

1. A dark-field confocal microscopic measurement apparatus based on frequency mismatch demodulation, comprising a dual-channel waveform generator, a modulated illumination module, an optical scanning module, a mismatch demodulation module, and an axial displacement table, wherein a sample is placed on the axial displacement table, and one channel of the dual-channel waveform generator is connected to the modulated illumination module; laser emitted by the modulated illumination module irradiates the sample through the optical scanning module, and returned light of the sample is collected by the mismatch demodulation module;
wherein one channel of the dual-channel waveform generator outputs a square-wave pulse sequence with a frequency of f to an LD (Laser Diode) laser device, 500 kHz≤f≤10 MHz, and the LD laser device outputs intensity-modulated linearly polarized laser with a modulation frequency of f;
wherein an other channel of the dual-channel waveform generator outputs a trigonometric function signal with a frequency of f+Δf to a lock-in amplifier as a reference waveform, and an output electric signal of a PMT (Photomultiplier tube) detector is connected to an input channel of the lock-in amplifier, Δf is set to f/10, 500 kHz≤f≤10 MHz.

2. The dark-field confocal microscopic measurement apparatus based on frequency mismatch demodulation according to claim 1, wherein the modulated illumination module comprises an LD laser device, a single-mode fiber, a fiber collimator lens, and a unpolarized beam splitter; the LD laser device, the single-mode fiber, the fiber collimator lens and the unpolarized beam splitter are sequentially arranged from left to right; the LD laser device is connected to one channel of the dual-channel waveform generator, and laser emitted by the LD laser device enters the optical scanning module via the single-mode fiber, the fiber collimator lens and the unpolarized beam splitter.

3. The dark-field confocal microscopic measurement apparatus based on frequency mismatch demodulation according to claim 1, wherein the optical scanning module comprises a galvanometer, a scanning lens, a tube lens, and an objective lens; the galvanometer, the scanning lens, the tube lens and the objective lens are arranged in sequence, and laser emitted by the LD laser device enters the galvanometer after passing through the single-mode fiber, the fiber collimator and the unpolarized beam splitter in sequence, and then irradiates the sample after passing through the scanning lens, the tube lens and the objective lens in sequence.

4. The dark-field confocal microscopic measurement apparatus based on frequency mismatch demodulation according to claim 1, wherein the mismatch demodulation module comprises a focusing lens, a pinhole, the PMT detector, and the lock-in amplifier; the returned light of the sample is focused to the pinhole by the focusing lens and collected by the PMT detector, and an output electric signal of the PMT detector is connected to an input channel of the lock-in amplifier.

5. (canceled)

6. (canceled)

7. The dark-field confocal microscopic measurement apparatus based on frequency mismatch demodulation according to claim 4, wherein a demodulation frequency of the lock-in amplifier is f+Δf, and an output analog signal of the lock-in amplifier is collected, which is used to synchronously reconstruct a dark-field microscopic imaging result with scanning of a galvanometer, Δf is set to f/10, 500 kHz≤f≤10 MHz.

8. A dark-field confocal microscopic measurement method based on the dark-field confocal microscopic measurement apparatus according to claim 1, wherein the dark-field confocal microscopic measurement method based on frequency mismatch demodulation comprises the following steps:
Step 1, outputting, by one channel of a dual-channel waveform generator, a square-wave pulse sequence with a frequency of f to an LD laser device, and outputting, by the LD laser device, intensity-modified linearly polarized laser with a modulation frequency of f;
Step 2, outputting, by a fiber collimator lens, collimated light after a single-mode fiber is coupled with a laser, wherein the collimated light enters an optical scanning module through a non-polarized beam splitter, and then focuses on a sample through a galvanometer, a scanning lens, a tube lens and an objective lens;
Step 3, scanning a position of a focused spot by the galvanometer, and controlling a scanning rate of the galvanometer, thus making residence time of each scanning point more than 2/f;
Step 4, focusing returned light of the sample to a pinhole through a focusing lens, and collecting the returned light by the PMT detector;
Step 5, connecting an output electric signal of the PMT detector to an input channel of a lock-in amplifier, and outputting, by the other channel of the dual-channel waveform generator, a trigonometric function signal with a frequency of f+Δf to a reference channel of the lock-in amplifier;
Step 6, setting a demodulation frequency of the lock-in amplifier to f+Δf, and a mode of the lock-in amplifier is external reference; and collecting an output analog signal of the lock-in amplifier, which is used to synchronously reconstruct a dark-field microscopic imaging result with scanning of the galvanometer; and
Step 7, stepwise moving an axial displacement table by one step value to scan an axial position of the sample, and repeating Steps 1-6.

9. The dark-field confocal microscopic measurement apparatus based on frequency mismatch demodulation according to claim 2, wherein the optical scanning module comprises a galvanometer, a scanning lens, a tube lens, and an objective lens; the galvanometer, the scanning lens, the tube lens and the objective lens are arranged in sequence, and laser emitted by the LD laser device enters the galvanometer after passing through the single-mode fiber, the fiber collimator and the unpolarized beam splitter in sequence, and then irradiates the sample after passing through the scanning lens, the tube lens and the objective lens in sequence.

10. (canceled)

11. The dark-field confocal microscopic measurement method according to claim 8, wherein the modulated illumination module comprises an LD laser device, a single-mode fiber, a fiber collimator lens, and a unpolarized beam splitter; the LD laser device, the single-mode fiber, the fiber collimator lens and the unpolarized beam splitter are sequentially arranged from left to right; the LD laser device is connected to one channel of the dual-channel waveform generator, and laser emitted by the LD laser device enters the optical scanning module via the single-mode fiber, the fiber collimator lens and the unpolarized beam splitter.

12. The dark-field confocal microscopic measurement method according to claim 8, wherein the optical scanning module comprises a galvanometer, a scanning lens, a tube lens, and an objective lens; the galvanometer, the scanning lens, the tube lens and the objective lens are arranged in sequence, and laser emitted by the LD laser device enters the galvanometer after passing through the single-mode fiber, the fiber collimator and the unpolarized beam splitter in sequence, and then irradiates the sample after passing through the scanning lens, the tube lens and the objective lens in sequence.

13. The dark-field confocal microscopic measurement method according to claim 8, wherein the mismatch demodulation module comprises a focusing lens, a pinhole, a PMT (Photomultiplier tube) detector, and a lock-in amplifier; the returned light of the sample is focused to the pinhole by the focusing lens and collected by the PMT detector, and an output electric signal of the PMT detector is connected to an input channel of the lock-in amplifier.

14. (canceled)

15. (canceled)

16. The dark-field confocal microscopic measurement method according to claim 13, wherein a demodulation frequency of the lock-in amplifier is f+Δf, and an output analog signal of the lock-in amplifier is collected, which is used to synchronously reconstruct a dark-field microscopic imaging result with scanning of the galvanometer, Δf is set to f/10, 500 kHz≤f≤10 MHz.
